(19) United States
(12) Patent Application Publication
(10) Pub. No.: US 2026/0353394 A1
(43) Pub. Date: Nov. 5, 2026

(54) COMMUNICATION METHOD AND APPARATUS, DEVICE, AND STORAGE MEDIUM

(71) Applicant: Beijing Xiaomi Mobile Software Co., Ltd., Beijing (CN)

(72) Inventors: Qin MU, Beijing (CN); Xuemei QIAO, Beijing (CN)

(73) Assignee: Beijing Xiaomi Mobile Software Co., Ltd., Beijing (CN)

(21) Appl. No.: 19/122,488

(22) PCT Filed: Oct. 19, 2022
(86) PCT No.: PCT/CN2022/126281

§ 371 Date: Apr. 18, 2025

(51) Int. Cl. H04W 72/21; H04L 5/00; H04W 74/0833

(52) U.S. Cl. CPC H04W 72/21; H04L 5/0012; H04W 74/0833

(57) ABSTRACT

A method and system for wireless communication enable a terminal to determine a physical uplink control channel (PUCCH) transmission mode frequency hopping or non-frequency hopping during random access, based on its operating frequency band. When non-frequency hopping is used, the terminal calculates a physical resource block (PRB) index using parameters such as a PUCCH resource index, uplink bandwidth part (BWP) size, cyclic shift sequences, and PUCCH PRB settings. These may be derived from physical downlink control channel (PDCCH) or higher-layer signaling. A network device configures and coordinates the transmission mode accordingly. The invention includes related devices and storage media, and supports efficient random access in bands such as n8, n26, n28, and n100.

### CROSS REFERENCE TO RELATED APPLICATIONS

This application is a US National Phase of a PCT Application No. PCT/CN2022/126281 filed on Oct. 19, 2022, the entire contents of which are incorporated herein by reference in their entireties.

### TECHNICAL FIELD

The present disclosure relates to the field of communication technology, particularly to communication methods and apparatuses, devices, and storage media.

### BACKGROUND

In scenarios for spectrums below 5 MHz, corresponding research has been conducted on supporting new radio (NR) technology in some dedicated frequency bands. These dedicated spectrums can be used to provide services for specific businesses.

For these dedicated frequency bands, the spectrums only support subcarrier spacing of 15 KHz, and the system bandwidth is typically 5 MHz or 3 MHz. According to the regulations of NR and Long term Evolution (LTE) for radio frequency (RF) channels, a system bandwidth of 5 MHz can include 25 resource blocks (RBs). According to LTE regulations for RF channels, a system bandwidth of 3 MHz can include 15 RBs.

At present, in the initial uplink (UL) bandwidth part (BWP), the physical uplink control channel (PUCCH) is configured by default for data transmission by frequency hopping. Regarding the frequency hopping, for a time slot in the PUCCH, the data transmitted in the first half of the time slot can be transmitted on any one physical resource block (PRB) in the initial UL BWP, and the data transmitted in the second half of the time slot can be transmitted on another PRB in the initial UL BWP.

However, for some of the smaller bandwidths, hopping on the PUCCH can cause serious resource waste. Therefore, how to avoid resource waste caused by frequency hopping of PUCCH is a problem that needs to be solved.

### SUMMARY

To overcome the problems existing in related technologies, the present disclosure provides communication methods and apparatuses, devices, and storage media.

According to the first aspect of the embodiments of the present disclosure, a communication method is provided, performed by a terminal, including: in response to an operating frequency band of the terminal meeting a condition, and the terminal performing physical uplink control channel (PUCCH) transmission based on the operating frequency band during random access, determining a transmission mode for the PUCCH, where the transmission mode for the PUCCH includes frequency hopping transmission or non-frequency hopping transmission; and performing random access based on the determined transmission mode for the PUCCH.

In an embodiment, performing the random access based on the determined transmission mode for the PUCCH includes: in response to the transmission mode for the PUCCH being non-frequency hopping transmission, determining a PRB index for the PUCCH based on at least one of: a PUCCH resource index, an amount of uplink bandwidth part (BWP) resources, a number of cyclic shift sequences, or a PUCCH physical resource block (PRB) parameter; and performing the random access on a PRB corresponding to the PRB index.

In an embodiment, the PUCCH resource index is determined based on a parameter of a physical downlink control channel (PDCCH) used in the random access.

In an embodiment, the parameter of the PDCCH includes at least one of: control channel element (CCE) information occupied by the PDCCH; or PUCCH resource allocation information contained in the PDCCH.

In an embodiment, one or more of the amount of uplink BWP resources, the number of cyclic shift sequences, or the PUCCH PRB parameter are configured based on higher-layer signaling transmitted by a network device.

In an embodiment, determining the PRB index for the PUCCH based on at least one of: the PUCCH resource index, the amount of uplink BWP resources, the number of cyclic shift sequences, or the PUCCH PRB parameter includes: determining a first PRB index based on the PUCCH resource index, the number of cyclic shift sequences, and the PUCCH PRB parameter.

In an embodiment, determining the PRB index for the PUCCH based on at least one of: the PUCCH resource index, the amount of uplink BWP resources, the number of cyclic shift sequences, or the PUCCH PRB parameter includes: determining a second PRB index based on the PUCCH resource index, the amount of uplink BWP resources, the number of cyclic shift sequences, and the PUCCH PRB parameter.

In an embodiment, performing the random access on the PRB corresponding to the PRB index includes: determining an index of a cyclic shift sequence based on the PUCCH resource index and the number of cyclic shift sequences, where a cyclic shift sequence corresponding to the index of the cyclic shift sequence is for multiplexing the PRB corresponding to the PRB index; and multiplexing the PRB corresponding to the PRB index during the random access by the cyclic shift sequence corresponding to the index of the cyclic shift sequence.

In an embodiment, the index of the cyclic shift sequence is equal to the PUCCH resource index modulo the number of cyclic shift sequences.

In an embodiment, determining the transmission mode for the PUCCH includes: receiving frequency hopping indication information transmitted by a network device, where the frequency hopping indication information is configured to indicate whether the transmission mode for the PUCCH is frequency hopping transmission or non-frequency hopping transmission; and determining the transmission mode for the PUCCH based on the frequency hopping indication information.

In an embodiment, the frequency hopping indication information includes a PRB index indicator; and the PRB index indicator indicates whether a PRB used for the random access is a PRB corresponding to a first PRB index or a PRB corresponding to a second PRB index.

In an embodiment, determining the transmission mode for the PUCCH includes: determining the transmission mode for the PUCCH based on a predefined rule.

In an embodiment, the transmission mode of PUCCH defaults to non-frequency hopping transmission.

In an embodiment, the operating frequency band meeting the condition includes at least one of: a frequency band number of the operating frequency band is n8; a frequency band number of the operating frequency band is n26; a frequency band number of the operating frequency band is n28; or a frequency band number of the operating frequency band is n100.

According to the second aspect of the embodiments of the present disclosure, a communication method is provided, performed by a network device, including: in response to an operating frequency band of a terminal meeting a condition, configuring a transmission mode for a physical uplink control channel (PUCCH) by which the terminal performs PUCCH transmission based on the operating frequency band during random access, where the transmission mode for the PUCCH includes frequency hopping transmission or non-frequency hopping transmission; and performing random access with the terminal based on the transmission mode for the PUCCH.

In an embodiment, performing the random access with the terminal based on the transmission mode for the PUCCH includes: in response to the transmission mode for the PUCCH being non-frequency hopping transmission, determining a PRB index for the PUCCH based on at least one of: a PUCCH resource index, an amount of uplink bandwidth part (BWP) resources, a number of cyclic shift sequences, or a PUCCH physical resource block (PRB) parameter; and performing the random access with the terminal on a PRB corresponding to the PRB index.

In an embodiment, the PUCCH resource index is determined based on a parameter of a physical downlink control channel (PDCCH) used in the random access.

In an embodiment, the parameter of the PDCCH includes at least one of: control channel element (CCE) information occupied by the PDCCH; or PUCCH resource allocation information contained in the PDCCH.

In an embodiment, one or more of the amount of uplink BWP resources, the number of cyclic shift sequences, or the PUCCH PRB parameters are configured based on higher-layer signaling from the network device.

In an embodiment, determining the PRB index for the PUCCH based on at least one of: the PUCCH resource index, the amount of uplink BWP resources, the number of cyclic shift sequences, or the PUCCH PRB parameter includes: determining a first PRB index based on the PUCCH resource index, the number of cyclic shift sequences, and the PUCCH PRB parameter.

In an embodiment, determining the PRB index for the PUCCH based on at least one of: the PUCCH resource index, the amount of uplink BWP resources, the number of cyclic shift sequences, or the PUCCH PRB parameter includes: determining a second PRB index based on the PUCCH resource index, the amount of uplink BWP resources, the number of cyclic shift sequences, and the PUCCH PRB parameter.

In an embodiment, performing the random access with the terminal on the PRB corresponding to the PRB index includes: determining an index of a cyclic shift sequence based on the PUCCH resource index and the number of cyclic shift sequences, where a cyclic shift sequence corresponding to the index of the cyclic shift sequence is for multiplexing the PRB corresponding to the PRB index; and multiplexing the PRB corresponding to the PRB index during the random access by the cyclic shift sequence corresponding to the index of the cyclic shift sequence.

In an embodiment, the index of the cyclic shift sequence is equal to the PUCCH resource index modulo the number of cyclic shift sequences.

In an embodiment, the method further includes: transmitting frequency hopping indication information to the terminal, where the frequency hopping indication information is configured to indicate whether the transmission mode for the PUCCH is frequency hopping transmission or non-frequency hopping transmission.

In an embodiment, the frequency hopping indication information includes a PRB index indicator; and the PRB index indicator indicates whether a PRB used for the random access is a PRB corresponding to a first PRB index or a PRB corresponding to a second PRB index.

In an embodiment, configuring the transmission mode for the PUCCH by which the terminal performs PUCCH transmission based on the operating frequency band during the random access includes: configuring the transmission mode for the PUCCH based on a predefined rule.

In an embodiment, the transmission mode of PUCCH defaults to non-frequency hopping transmission.

In an embodiment, the operating frequency band meeting the condition includes at least one of: a frequency band number of the operating frequency band is n8; a frequency band number of the operating frequency band is n26; a frequency band number of the operating frequency band is n28; or a frequency band number of the operating frequency band is n100.

According to the third aspect of the embodiments of the present disclosure, a communication apparatus is provided, configured on a terminal, including: a determining module, configured to, in response to an operating frequency band of the terminal meeting a condition, and the terminal performing PUCCH transmission based on the operating frequency band during random access, determine a transmission mode for the PUCCH, where the transmission mode for the PUCCH includes frequency hopping transmission or non-frequency hopping transmission; and a communication module, configured to perform random access based on the determined transmission mode for the PUCCH.

In an embodiment, the determining module is further configured to, in response to the transmission mode for the PUCCH being non-frequency hopping transmission, determine a PRB index for the PUCCH based on at least one of: a PUCCH resource index, an amount of uplink bandwidth part (BWP) resources, a number of cyclic shift sequences, or a PUCCH physical resource block (PRB) parameter; and the communication module is further configured to perform random access on the PRB corresponding to the PRB index.

In an embodiment, the PUCCH resource index is determined based on a parameter of a physical downlink control channel (PDCCH) used in the random access.

In an embodiment, the parameter of the PDCCH includes at least one of: control channel element (CCE) information occupied by the PDCCH; or PUCCH resource allocation information contained in the PDCCH.

In an embodiment, one or more of the amount of uplink BWP resources, the number of cyclic shift sequences, or the PUCCH PRB parameter are configured based on higher-layer signaling transmitted by a network device.

In an embodiment, the determining module is further configured to determine the first PRB index based on the PUCCH resource index, the number of cyclic shift sequences, and the PUCCH PRB parameter.

In an embodiment, the determining module is further configured to determine the second PRB index based on the PUCCH resource index, the amount of uplink BWP resources, number of cyclic shift sequences, and PUCCH PRB parameters.

In an embodiment, the determining module is further configured to determine an index of a cyclic shift sequence based on the PUCCH resource index and the number of cyclic shift sequences, where a cyclic shift sequence corresponding to the index of the cyclic shift sequence is for multiplexing the PRB corresponding to the PRB index; and the communication module is further configured to multiplex the PRB corresponding to the PRB index during the random access by the cyclic shift sequence corresponding to the index of the cyclic shift sequence.

In an embodiment, the index of the cyclic shift sequence is equal to the PUCCH resource index modulo the number of cyclic shift sequences.

In an embodiment, apparatus further includes a receiving module configured to receive frequency hopping indication information transmitted by a network device, where the frequency hopping indication information is configured to indicate whether the transmission mode for the PUCCH is frequency hopping transmission or non-frequency hopping transmission; and the determining module is further configured to determine the transmission mode for the PUCCH based on the frequency hopping indication information.

In an embodiment, the frequency hopping indication information includes a PRB index indicator; and the PRB index indicator indicates whether a PRB used for the random access is a PRB corresponding to a first PRB index or a PRB corresponding to a second PRB index.

In an embodiment, the determining module is further configured to determine the transmission mode for the PUCCH based on a predefined rule.

In an embodiment, the transmission mode of PUCCH defaults to non-frequency hopping transmission.

In an embodiment, the operating frequency band meeting the condition includes at least one of: a frequency band number of the operating frequency band is n8; a frequency band number of the operating frequency band is n26; a frequency band number of the operating frequency band is n28; or a frequency band number of the operating frequency band is n100.

According to the fourth aspect of the embodiments of the present disclosure, a communication apparatus is provided, configured on a network device, including: a configuring module, configured to, in response to an operating frequency band of a terminal meeting a condition, configure a transmission mode for a physical uplink control channel (PUCCH) by which the terminal performs PUCCH transmission based on the operating frequency band during random access, where the transmission mode for the PUCCH includes frequency hopping transmission or non-frequency hopping transmission; and a communication module, configured to perform random access with the terminal based on the transmission mode for the PUCCH.

In an embodiment, the apparatus further includes a determining module, configured to, in response to the transmission mode for the PUCCH being non-frequency hopping transmission, determine a PRB index for the PUCCH based on at least one of: a PUCCH resource index, an amount of uplink bandwidth part (BWP) resources, a number of cyclic shift sequences, or a PUCCH physical resource block (PRB) parameter; and the communication module is further configured to perform the random access with the terminal on a PRB corresponding to the PRB index.

In an embodiment, the PUCCH resource index is determined based on a parameter of a physical downlink control channel (PDCCH) used in the random access.

In an embodiment, the parameter of the PDCCH includes at least one of: control channel element (CCE) information occupied by the PDCCH; or PUCCH resource allocation information contained in the PDCCH.

In an embodiment, one or more of the amount of uplink BWP resources, the number of cyclic shift sequences, or the PUCCH PRB parameters are configured based on higher-layer signaling from the network device.

In an embodiment, the determining module is further configured to determine the first PRB index based on the PUCCH resource index, the number of cyclic shift sequences, and the PUCCH PRB parameter.

In an embodiment, the determining module is further configured to determine the second PRB index based on the PUCCH resource index, the amount of uplink BWP resources, number of cyclic shift sequences, and PUCCH PRB parameters.

In an embodiment, the determining module is further configured to determine an index of a cyclic shift sequence based on the PUCCH resource index and the number of cyclic shift sequences, where a cyclic shift sequence corresponding to the index of the cyclic shift sequence is for multiplexing the PRB corresponding to the PRB index; and the communication module is further configured to multiplex the PRB corresponding to the PRB index during the random access by the cyclic shift sequence corresponding to the index of the cyclic shift sequence.

In an embodiment, the index of the cyclic shift sequence is equal to the PUCCH resource index modulo the number of cyclic shift sequences.

In an embodiment, the apparatus further includes a transmitting module configured to transmit frequency hopping indication information to the terminal, where the frequency hopping indication information is configured to indicate whether the transmission mode is frequency hopping transmission or non-frequency hopping transmission.

In an embodiment, the frequency hopping indication information includes a PRB index indicator; and the PRB index indicator indicates whether a PRB used for the random access is a PRB corresponding to a first PRB index or a PRB corresponding to a second PRB index.

In an embodiment, the configuring module is further configured to configure the transmission mode of PUCCH based on the predefined rule.

In an embodiment, the transmission mode of PUCCH defaults to non-frequency hopping transmission.

In an embodiment, the operating frequency band meeting the condition includes at least one of: a frequency band number of the operating frequency band is n8; a frequency band number of the operating frequency band is n26; a frequency band number of the operating frequency band is n28; or a frequency band number of the operating frequency band is n100.

According to the fifth aspect of the disclosed embodiment, a communication device is provided, including: one or more processors; and one or more memories storing executable instructions; where the one or more processors are configured to execute any one of the methods in the first aspect.

According to the sixth aspect of the disclosed embodiment, a communication device is provided, including: one or more processors; and one or more memories storing executable instructions; where the one or more processors are configured to execute any one of the methods in the second aspect.

According to the seventh aspect of the embodiments of the present disclosure, a non temporary computer-readable storage medium is provided, where instructions in the storage medium are executed by one or more processors of a terminal, to enable the terminal to perform any one of the methods in the first aspect.

According to the eighth aspect of the embodiments of the present disclosure, a non temporary computer-readable storage medium is provided, where instructions in the storage medium are executed by one or more processors of a network device, to enable the network device to perform any one of the methods in the second aspect.

The technical solution provided by the embodiments of the present disclosure may include the following beneficial effects: by determining the transmission mode of PUCCH during the random access in the operating frequency band that meets the condition, frequency hopping transmission or non-frequency hopping transmission can be selected based on the transmission mode of PUCCH. Thus, avoiding resource waste caused by using PUCCH frequency hopping.

It is to be understood that the above general descriptions and the below detailed descriptions are merely exemplary and explanatory, and are not intended to limit the present disclosure.

### BRIEF DESCRIPTION OF DRAWINGS

Accompanying drawings herein are incorporated into and constitute a part of the specification, illustrate embodiments consistent with the present disclosure, and are combined with the description to explain the principle of the present disclosure.

FIG. 1 is a schematic diagram of a wireless communication system according to an exemplary embodiment.

FIG. 2 is a flowchart of a communication method according to an exemplary embodiment.

FIG. 3 is a flowchart of another communication method according to an exemplary embodiment.

FIG. 4 is a flowchart of another communication method according to an exemplary embodiment.

FIG. 5 is a flowchart of another communication method according to an exemplary embodiment.

FIG. 6 is a flowchart of another communication method according to an exemplary embodiment.

FIG. 7 is a flowchart of another communication method according to an exemplary embodiment.

FIG. 8 is a flowchart of another communication method according to an exemplary embodiment.

FIG. 9 is a flowchart of another communication method according to an exemplary embodiment.

FIG. 10 is a flowchart of another communication method according to an exemplary embodiment.

FIG. 11 is a flowchart of another communication method according to an exemplary embodiment.

FIG. 12 is a flowchart of another communication method according to an exemplary embodiment.

FIG. 13 is a flowchart of another communication method according to an exemplary embodiment.

FIG. 14 is a flowchart of another communication method according to an exemplary embodiment.

FIG. 15 is a flowchart of another communication method according to an exemplary embodiment.

FIG. 16 is a schematic diagram of a communication apparatus according to an exemplary embodiment.

FIG. 17 is a schematic diagram of a communication apparatus according to an exemplary embodiment.

FIG. 18 is a schematic diagram of a communication device according to an exemplary embodiment.

FIG. 19 is a schematic diagram of a communication device according to an exemplary embodiment.

### DETAILED DESCRIPTION

Embodiments will be described in detail here, and examples thereof will be expressed in the drawings. When the following descriptions involve the drawings, like numerals in different drawings represent like or similar elements unless stated otherwise. Embodiments described in the illustrative examples below are not intended to represent all embodiments consistent with the present disclosure.

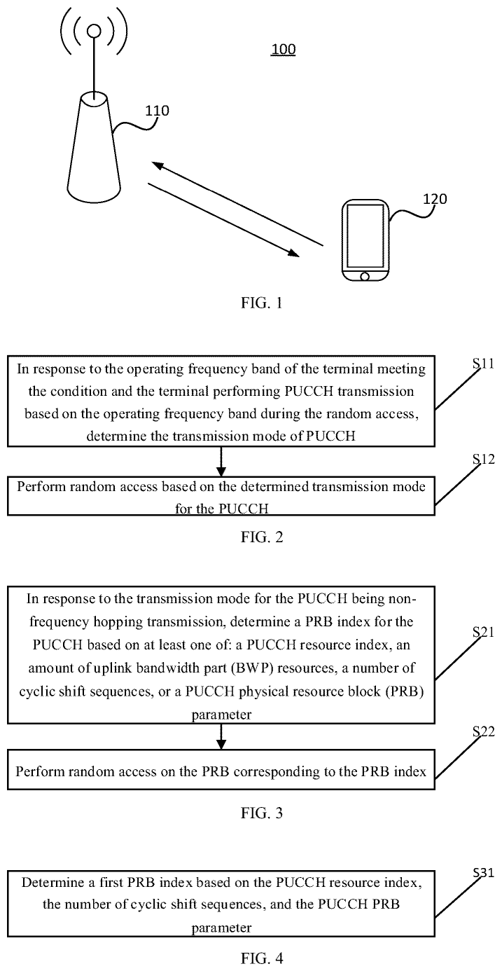

The communication method in the present disclosure can be applied to the wireless communication system 100 shown in FIG. 1. The communication system may include a network device 110 and a terminal 120. It can be understood that the wireless communication system shown in FIG. 1 is only for illustrative purposes. The wireless communication system may also include other network devices, such as core network devices, wireless relay devices, and wireless backhaul devices, which are not shown in FIG. 1. The embodiments in the present disclosure do not limit the number of network devices and terminals included in the wireless communication system.

It can be further understood that the wireless communication system in the embodiments in the present disclosure is a network that provides wireless communication functionality. Wireless communication systems can adopt different communication technologies, such as Code Division Multiple Access (CDMA), Wideband Code Division Multiple Access (WCDMA), time Division Multiple Access (TDMA), Frequency Division Multiple Access (FDMA), Orthogonal Frequency Division Multiple Access (OFDMA), Single Carrier Frequency Division Multiple Access (SC-FDMA), or Carrier Sense Multiple Access with Collision Avoidance. According to factors such as capacity, speed, and latency of different networks, networks can be classified into 2nd-Generation (2G) networks, 3G networks, 4G networks, or future evolution networks, such as The 5th Generation Wireless Communication System (5G) networks, where the 5G networks can also be referred to as New Radio (NR) networks. For ease of description, wireless communication networks are sometimes referred to as networks in the present disclosure.

Furthermore, the network device 110 referred to in the present disclosure can also be referred to as a wireless access network device. The wireless access network device can be a base station, an evolved Node B (eNB), a home base station, an access point (AP) in a wireless fidelity (WIFI) system, a wireless relay node, a wireless backhaul node, or a transmission point (TP), etc. The wireless access network device can also be a gNB in an NR system, or a component or part of the equipment that makes up the base station. For V2X communication systems, the network device can also be in-vehicle devices. It should be understood in the embodiments of the present disclosure do not limit the specific technology or specific device form adopted by the network device.

Furthermore, the terminal 120 referred to in the present disclosure, also known as a terminal device, user equipment (UE), mobile station (MS), mobile terminal (MT), etc., is a device that provides voice and/or data connectivity to users. For example, the terminal may be a handheld device with wireless connectivity, an in-vehicle device, etc. At present, some examples of terminals include smartphones (Mobile Phone), Pocket Personal Computers (PPC), handheld computers, Personal Digital Assistants (PDA), laptops, tablets, wearable devices, or in-vehicle devices. In addition, for V2X communication systems, the terminal device can also be an in-vehicle device. It should be understood that the embodiments in the present disclosure do not limit the specific technology and device form adopted by the terminal.

In the embodiments in the present disclosure, the network device 110 and the terminal 120 can use any feasible wireless communication technology to achieve mutual data transmission. Where the transmission channel for the data transmitted from the network device 110 to the terminal 120 is called the downlink (DL) channel, and the transmission channel for the data transmitted from the terminal 120 to the network device 110 is called the uplink (UL) channel. It can be understood that the network device involved in the embodiments in the present disclosure may be a base station. In some embodiments, the network device can also be any other possible network devices, and the terminal can be any possible terminals, which is not limited in the present disclosure.

In the scenarios for the spectrums below 5 MHz, R18 studied the support of NR technology for some dedicated spectrums of the Global System for Mobile Communications-Railway (GSM-R) and LTE. These spectrums mainly provide services for specialized communication in power systems, railway systems, public protection, and disaster relief businesses.

The spectrums only support subcarrier spacing of 15 KHz for these dedicated frequency bands, and the system bandwidth typically includes 5 MHz or 3 MHz. According to NR and LTE bandwidth regulations for RF channels, a system bandwidth of 5 MHz can include 25 RBs. According to LTE bandwidth regulations for RF channels, a system bandwidth of 3 MHz can include 15 RBs.

In the current NR protocol, the PUCCH on the initial UL BWP can be used for at least the feedback for a hybrid automatic repeat request (HARQ) of message 4 in the 4-step random access, or the feedback for HARQ of message B in the 2-step random access. Where the physical resources of PUCCH are configured based on broadcast messages. The protocol predefines a possible resource configuration set for this PUCCH. For example, as shown in table 1.

TABLE 1

| | | | Number of | | Set of initial |
|---|---|---|---|---|---|
| | PUCCH | First | occupied | PRB | cyclic shift |
| Index | format | symbol | symbols | offset | indices |
| 0 | 0 | 12 | 2 | 0 | {0, 3} |
| 1 | 0 | 12 | 2 | 0 | {0, 4, 8} |
| 2 | 0 | 12 | 2 | 3 | {0, 4, 8} |
| 3 | 1 | 10 | 4 | 0 | {0, 6} |
| 4 | 1 | 10 | 4 | 0 | {0, 3, 6, 9} |
| 5 | 1 | 10 | 4 | 2 | {0, 3, 6, 9} |
| 6 | 1 | 10 | 4 | 4 | {0, 3, 6, 9} |
| 7 | 1 | 4 | 10 | 0 | {0, 6} |
| 8 | 1 | 4 | 10 | 0 | {0, 3, 6, 9} |
| 9 | 1 | 4 | 10 | 2 | {0, 3, 6, 9} |
| 10 | 1 | 4 | 10 | 4 | {0, 3, 6, 9} |
| 11 | 1 | 0 | 14 | 0 | {0, 6} |
| 12 | 1 | 0 | 14 | 0 | {0, 3, 6, 9} |
| 13 | 1 | 0 | 14 | 2 | {0, 3, 6, 9} |
| 14 | 1 | 0 | 14 | 4 | {0, 3, 6, 9} |
| 15 | 1 | 0 | 14 | $\frac{{N}_{BWP}^{size}}{4}$ | {0, 3, 6, 9} |

Where

$${N}_{BWP}^{size}$$

represents the number of PRBs in the initial UL BWP. The PUCCH resource configuration set shown in table 1 above includes the transmission format of the PUCCH, the orthogonal frequency division multiplexing (OFDM) symbol resources occupied in the time domain, the PRB parameters in the initial UL BWP, and the cyclic shift (CS) sequence parameters for multiplexing the PUCCH in a PRB. Where the OFDM symbol resources occupied in the time domain may include, for example, the first symbol and the number of occupied symbols. For example, the PRB parameters may include PRB offset.

Each row in table 1 represents a resource configuration set and corresponds to one index. The network device can notify this index through a system information block (SIB) message. The terminal can determine the transmission configuration related to PUCCH through this index and the preset information in table 1.

Meanwhile, the PUCCH configured in the initial UL BWP defaults to using frequency hopping for data transmission. The frequency hopping (also known as frequency hopping transmission) means that for a time slot in the PUCCH, the data transmitted in the first half of the time slot can be transmitted on any one PRB in the initial UL BWP, and the data transmitted in the second half of the time slot can be transmitted on another PRB in the initial UL BWP.

For example, if

$$⌊ \frac{{r}_{PUCCH}}{8} ⌋ = 0$$

is satisfied, the PRB index of the PRB where the first hop of the corresponding PUCCH is located can be

$${RB}_{BWP}^{offset} + ⌊ \frac{{r}_{PUCCH}}{{N}_{CS}} ⌋ ,$$

the PRB index of the PRB where the second hop is located can be

$${N}_{BWP}^{size} - 1 - {RB}_{BWP}^{offset} - ⌊ \frac{{r}_{PUCCH}}{{N}_{CS}} ⌋ ,$$

and the corresponding cyclic shift sequence can be r_{PUCCH} mod N_{CS}.

For example, if

$$⌊ \frac{{r}_{PUCCH}}{8} ⌋ = 1$$

is satisfied, the PRB index of the PRB where the first hop of the corresponding PUCCH is located can be

$${N}_{BWP}^{size} - 1 - {RB}_{BWP}^{offset} - ⌊ \frac{{r}_{PUCCH}}{{N}_{CS}} ⌋ ,$$

the PRB index of the PRB where the second hop is located can be

$${RB}_{BWP}^{offset} + ⌊ \frac{{r}_{PUCCH}}{{N}_{CS}} ⌋ ,$$

and the corresponding cyclic shift sequence can be (r_{PUCCH}−8) mod N_{CS}.

Where r_{PUCCH} represents the PUCCH resource index calculated by the terminal based on scheduling information. It can be understood that this r_{PUCCH} and the index in the first column in table 1 are not the same index.

$${RB}_{BWP}^{offset}$$

represents the PRB offset, its value can refer to the corresponding value in the “PRB offset” column of table 1. N_{CS} represents the number of indexes in a cyclic shift sequence. mod represents modulo operation.

However, for some of the smaller bandwidths, the hopping gain that can be obtained by hopping on the PUCCH is very limited. It can be understood that the wider the bandwidth, the higher the hopping gain that can be obtained through PUCCH hopping. Meanwhile, if PUCCH frequency hopping is used, there will be serious resource waste when the number of terminals in a cell is small. This waste of resources will have a more serious impact on the scheduling of small bandwidth scenarios.

Therefore, how to avoid resource waste caused by frequency hopping of PUCCH is a problem that needs to be solved.

The present disclosure provides a communication method that determines the transmission mode for the PUCCH during the random access, in order to select frequency hopping transmission or non-frequency hopping transmission based on the transmission mode for the PUCCH. Thus, avoiding resource waste caused by using PUCCH frequency hopping.

FIG. 2 is a flowchart of a communication method according to an exemplary embodiment. As shown in FIG. 2, the method is performed by a terminal may include the following steps S11 to S12.

In step S11, in response to the operating frequency band of the terminal meeting the condition and the terminal performing PUCCH transmission based on the operating frequency band during the random access, the transmission mode of PUCCH is determined.

In some embodiments, the operating frequency band of the terminal may meet the condition. For example, the operating frequency band condition can be preset. In response to the operating frequency band of the terminal meeting the condition and the terminal performing PUCCH transmission based on the operating frequency band during the random access, the terminal determines the transmission mode of PUCCH. Where the transmission mode for PUCCH includes frequency hopping transmission or non-frequency hopping transmission.

For example, the operating frequency band of the terminal can meet the preset operating frequency band condition. The terminal performs PUCCH transmission based on the operating frequency band during the random access, and the terminal can determine that the transmission mode of PUCCH is frequency hopping transmission.

For example, the operating frequency band of the terminal can meet the preset operating frequency band condition. The terminal performs PUCCH transmission based on the operating frequency band during the random access, and the terminal can determine that the transmission mode of PUCCH is non-frequency hopping transmission.

It can be understood that the non-frequency hopping transmission is transmission without frequency hopping or not frequency hopping transmission.

In step S12, random access is performed based on the determined transmission mode for the PUCCH.

In some embodiments, the terminal may perform random access using the determined transmission mode for the PUCCH based on the transmission mode determined in S11.

For example, using a determined transmission mode for the PUCCH for the random access can include using PUCCH to carry HARQ feedback for Msg.4 in 4-step random access, or using PUCCH to carry HARQ feedback in 2-step random access.

The present disclosure determines the transmission mode of PUCCH when performing PUCCH transmission during the random access in the operating frequency band that meets the condition, in order to select frequency hopping transmission or non-frequency hopping transmission based on the transmission mode of PUCCH. Thus, resource waste caused by using PUCCH frequency hopping is avoided.

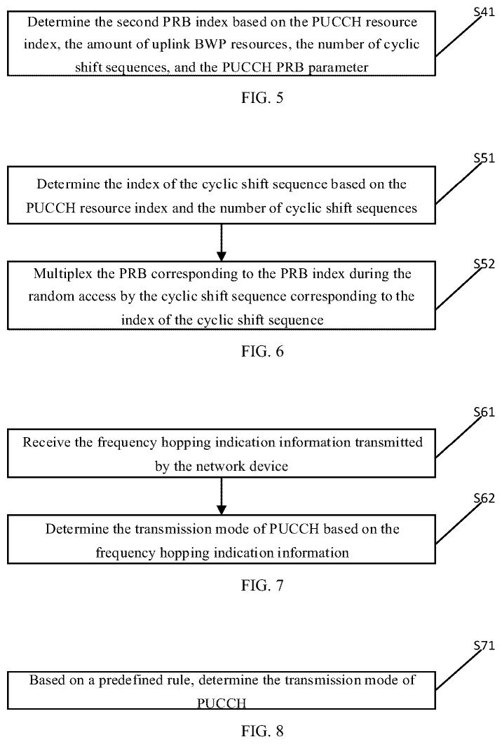

In the communication method provided in the embodiments in the present disclosure, FIG. 3 is a flowchart of another communication method according to an exemplary embodiment. As shown in FIG. 3, in S12, performing random access based on the determined transmission mode for the PUCCH can include the following steps S21 to S22.

In step S21, in response to the transmission mode for the PUCCH being non-frequency hopping transmission, a PRB index for the PUCCH is determined based on at least one of: a PUCCH resource index, an amount of uplink bandwidth part (BWP) resources, a number of cyclic shift sequences, or a PUCCH physical resource block (PRB) parameter; and

In some embodiments, in response to the transmission mode for the PUCCH being non-frequency hopping transmission, the terminal may determine the PRB index for the PUCCH based on at least one of the PUCCH resource index, the amount of uplink BWP resources, the number of cyclic shift sequences, or the PUCCH PRB parameter.

In step S22, random access is performed on the PRB corresponding to the PRB index.

In some embodiments, the terminal performs random access on the PRB corresponding to the PRB index determined in S21.

When using non-frequency hopping transmission for the PUCCH, the PRB index can be determined by the PUCCH resource index, the amount of uplink BWP resources, the number of cyclic shift sequences, and the PUCCH PRB parameter, such that the terminal can use non-frequency hopping transmission for random access, avoiding resource waste caused by using PUCCH frequency hopping.

In the communication method provided in the embodiments in the present disclosure, the PUCCH resource index is determined based on the parameter of the physical downlink control channel (PDCCH) used in the random access.

In some embodiments, the PUCCH resource index may be determined by the relevant parameters of the PDCCH for scheduling data.

The present disclosure determines the PUCCH resource index through the relevant parameters of the PDCCH, in order to determine the PRB index based on the PUCCH resource index, such that the terminal can use non-frequency hopping transmission for random access, avoiding resource waste caused by using PUCCH frequency hopping.

In the communication method provided in the embodiments in the present disclosure, the parameter(s) of the PDCCH may include at least one of the following: control channel element (CCE) information occupied by the PDCCH; or the PUCCH resource allocation information contained in the PDCCH.

In some embodiments, the parameters of the PDCCH may include control channel element (CCE) information occupied by the PDCCH.

For example, the terminal can determine the PUCCH resource index based on the CCE information occupied by the PDCCH.

In some embodiments, the parameters of the PDCCH may include the PUCCH resource allocation information contained in the PDCCH.

For example, the terminal can determine the PUCCH resource index based on the PUCCH resource allocation information contained in the PDCCH.

In some embodiments, the parameters of the PDCCH may include CCE information occupied by the PDCCH and PUCCH resource allocation information contained in the PDCCH.

For example, the terminal can determine the PUCCH resource index based on the CCE information occupied by the PDCCH and the PUCCH resource allocation information contained in the PDCCH.

The present disclosure determines the PUCCH resource index based on the CCE information occupied by the PDCCH and/or the PUCCH resource allocation information contained in the PDCCH, in order to determine the PRB index based on the PUCCH resource index, such that the terminal can use non-frequency hopping transmission for random access, avoiding resource waste caused by using PUCCH frequency hopping.

In the communication method provided in the embodiments in the present disclosure, one or more of the amount of uplink BWP resources, the number of cyclic shift sequences, or the PUCCH PRB parameter are configured based on higher-layer signaling transmitted by a network device.

In some embodiments, the amount of uplink BWP resources can be configured by higher-layer signaling transmitted by the network device.

In some embodiments, the number of cyclic shift sequences can be configured by higher-layer signaling transmitted by the network device.

In some embodiments, the PUCCH PRB parameter can be configured by higher-layer signaling transmitted by the network device.

In some embodiments, the higher-layer signaling can be configured based on the parameters shown in table 1.

In some embodiments, the higher-layer signaling can be configured based on the parameters shown in table 2.

TABLE 2

| | | | Number of | | Set of initial |
|---|---|---|---|---|---|
| | PUCCH | First | occupied | PRB | cyclic shift |
| Index | format | symbol | symbols | offset | indices |
| 0 | 0 | 12 | 2 | 0 | {0, 3} |
| 1 | 0 | 12 | 2 | 0 | {0, 4, 8} |
| 2 | 1 | 10 | 4 | 0 | {0, 6} |
| 3 | 1 | 10 | 4 | 0 | {0, 3, 6, 9} |
| 4 | 1 | 4 | 10 | 0 | {0, 6} |
| 5 | 1 | 4 | 10 | 0 | {0, 3, 6, 9} |
| 6 | 1 | 0 | 14 | 0 | {0, 6} |
| 7 | 1 | 0 | 14 | 0 | {0, 3, 6, 9} |

It can be seen that table 2 is similar to table 1, but the number of PUCCH resource configuration sets in table 2 is less than the number of PUCCH resource configuration sets in table 1. That is, the present disclosure further provides another possible configuration set for PUCCH. The specific parameters in table 2 are only one example, and the core lies in reducing the number of PUCCH resource configuration sets in table 1. A portion can be selected as the possible resource configuration set for the new PUCCH.

Of course, table 2 can be any subset of the number of PUCCH resource configuration sets in table 1. Any number of PUCCH resource configuration sets can be selected in any way according to the actual situation as the new possible resource configuration sets for PUCCH. In some embodiments, a partial of PUCCH resource configuration sets with PRB offset of 0 can be selected as new possible resource configuration sets for the PUCCH, which is not limited in the present disclosure.

It can be understood that the present disclosure provides possible resource configuration sets for PUCCH as shown in table 2, taking into account the need to reduce the computational complexity of determining PRB indices and alleviate the complexity of PUCCH resource configuration in actual traffic processes. Therefore, less PUCCH resource configuration sets can be used to determine the index of PRB in non-frequency hopping transmission.

The present disclosure configures one or more of the amount of uplink BWP resources, the number of cyclic shift sequences, and PUCCH PRB parameters through higher-layer signaling to determine the PRB index, such that the terminal can use non-frequency hopping transmission for random access, avoiding resource waste caused by using PUCCH frequency hopping.

In the communication method provided in the embodiments in the present disclosure, FIG. 4 is a flowchart of another communication method according to an exemplary embodiment. As shown in FIG. 4, in S21, determining the PRB index for the PUCCH based on at least one of: a PUCCH resource index, an amount of uplink bandwidth part (BWP) resources, a number of cyclic shift sequences, or a PUCCH physical resource block (PRB) parameter may include the following step S31.

In step S31, a first PRB index is determined based on the PUCCH resource index, the number of cyclic shift sequences, and the PUCCH PRB parameter.

In some embodiments, the terminal may determine the first PRB index based on the PUCCH resource index, the number of cyclic shift sequences, and the PUCCH PRB parameter.

For example, the terminal can determine the first PRB index using the method shown in formula 1,

$${RB}_{BWP}^{offset} + ⌊ \frac{{r}_{PUCCH}}{{N}_{CS}} ⌋ \qquad Formula 1$$

Where r_{PUCCH} represents the PUCCH resource index, N_{CS} represents the number of cyclic shift sequences, and

$${RB}_{BWP}^{offset}$$

represents the PRB offset in the PUCCH PRB parameter.

The present disclosure can determine the PRB index through the PUCCH resource index, the number of cyclic shift sequences, and the PUCCH PRB parameters, such that the terminal can use non-frequency hopping transmission for random access, avoiding resource waste caused by using PUCCH frequency hopping.

In the communication method provided in the embodiments in the present disclosure, FIG. 5 is a flowchart of another communication method according to an exemplary embodiment. As shown in FIG. 5, in S21, determining the PRB index for the PUCCH based on at least one of: a PUCCH resource index, an amount of uplink bandwidth part (BWP) resources, a number of cyclic shift sequences, or a PUCCH physical resource block (PRB) parameter may include the following step S41.

In step S41, the second PRB index is determined based on the PUCCH resource index, the amount of uplink BWP resources, the number of cyclic shift sequences, and the PUCCH PRB parameter.

In some embodiments, the terminal may determine the second PRB index based on the PUCCH resource index, the amount of uplink BWP resources, number of cyclic shift sequences, and PUCCH PRB parameters.

For example, the terminal can determine the second PRB index using the method shown in formula 2,

$${N}_{BWP}^{size} - 1 - {RB}_{BWP}^{offset} - ⌊ \frac{{r}_{PUCCH}}{{N}_{C S}} ⌋ \qquad Formula 2$$

Where

$${N}_{BWP}^{size}$$

represents the amount of uplink BWP resources, such as the number of PRBs in the initial UL BWP.

In the present disclosure, the PRB index can be determined through the PUCCH resource index, the amount of uplink BWP resources, the number of cyclic shift sequences, and the PUCCH PRB parameters, such that the terminal can use non-frequency hopping transmission for random access, avoiding resource waste caused by using PUCCH frequency hopping.

In the communication method provided in the embodiments in the present disclosure, FIG. 6 is a flowchart of another communication method according to an exemplary embodiment. As shown in FIG. 6, S22, performing the random access on a PRB corresponding to the PRB index can include the following steps S51 to S52.

In step S51, the index of the cyclic shift sequence is determined based on the PUCCH resource index and the number of cyclic shift sequences.

In some embodiments, the terminal may determine the index of the cyclic shift sequence based on the PUCCH resource index and the number of cyclic shift sequences. Where the cyclic shift sequence corresponding to the index of the cyclic shift sequence is for multiplexing of the PRB corresponding to the PRB index.

For example, the terminal can determine the index of the cyclic shift sequence based on r_{PUCCH} and N_{CS}.

In step S52, the PRB corresponding to the PRB index is multiplexed during the random access by the cyclic shift sequence corresponding to the index of the cyclic shift sequence.

In some embodiments, the terminal may multiplex the PRB corresponding to the PRB index during the random access by the cyclic shift sequence corresponding to the index of the cyclic shift sequence. It can be understood that PRB can be multiplexed based on the code domain to form orthogonality between the multiplexed PRB and avoid signal interference.

The present disclosure achieves PRB multiplexing by determining the index of the cyclic shift sequence, such that the terminal can use non-frequency hopping transmission for random access, avoiding resource waste caused by using PUCCH frequency hopping.

In the communication method provided in the embodiments in the present disclosure, the index of the cyclic shift sequence is equal to the PUCCH resource index modulo the number of cyclic shift sequences.

In some embodiments, the terminal may determine the index of the cyclic shift sequence by the PUCCH resource index modulo the number of cyclic shift sequences. For example, it can be determined through formula 3.

r_{PUCCH} mod N_{CS} Formula 3

It can be understood that mod represents modulo operation. That is, the remainder of r_{PUCCH} divided by N_{CS} is determined as the index of the cyclic shift sequence.

In the present disclosure, the index of the cyclic shift sequence is determined by taking the modulo to achieve multiplexing of PRB, such that the terminal can use non-frequency hopping transmission for random access, avoiding resource waste caused by using PUCCH frequency hopping.

In the communication method provided in the embodiments in the present disclosure, FIG. 7 is a flowchart of another communication method according to an exemplary embodiment. As shown in FIG. 7, determining the transmission mode for the PUCCH in S11 can include the following steps S61 and S62.

In step S61, the frequency hopping indication information transmitted by the network device is received.

In some embodiments, the terminal may receive frequency hopping indication information transmitted by the network device. Where the frequency hopping indication information is configured to indicate whether the transmission mode of PUCCH is frequency hopping transmission or non-frequency hopping transmission.

For example, the terminal can receive system information transmitted by the network device, and the system information carries frequency hopping indication information. The frequency hopping indication information can notify whether the transmission mode for the PUCCH during the random access is frequency hopping transmission or non-frequency hopping transmission.

In step S62, the transmission mode of PUCCH is determined based on the frequency hopping indication information.

In some embodiments, the terminal may determine the transmission mode for the PUCCH based on the frequency hopping indication information received in S61.

For example, if the frequency hopping indication information indicates that the transmission mode of PUCCH is frequency hopping transmission, the terminal determines that the transmission mode of PUCCH is frequency hopping transmission. For example, if the frequency hopping indication information indicates that the transmission mode for the PUCCH is non-frequency hopping transmission, the terminal determines that the transmission mode for the PUCCH is non-frequency hopping transmission.

In the present disclosure, the frequency hopping indication information transmitted by the network device can indicate whether the transmission mode of PUCCH is frequency hopping transmission or non-frequency hopping transmission, such that the terminal can flexibly use non-frequency hopping transmission for random access, avoiding resource waste caused by using PUCCH frequency hopping.

In the communication method provided in the embodiments in the present disclosure, the frequency hopping indication information includes a PRB index indicator. Where the PRB index indicator indicates whether a PRB used for the random access is a PRB corresponding to a first PRB index or a PRB corresponding to a second PRB index.

In some embodiments, the frequency hopping indication information may include a PRB index indicator. The PRB index indicator indicates whether a PRB used for the random access is a PRB corresponding to a first PRB index or a PRB corresponding to a second PRB index.

For example, the PRB index indicator being a first preset value can indicate that the PRB used during the random access is the PRB corresponding to the first PRB index. The first PRB index can be determined using the method shown in formula 1, and during the random access, the corresponding PRB can be found using the first PRB index for the random access.

For example, the PRB index indicator being the second preset value can indicate that the PRB used during the random access is the PRB corresponding to the second PRB index. The second PRB index can be determined using the method shown in formula 2, and during the random access, the corresponding PRB can be found using the second PRB index for the random access.

The present disclosure uses a PRB index indicator to indicate the PRB used for random access, such that the terminal can use non-frequency hopping transmission for random access, avoiding resource waste caused by using PUCCH frequency hopping.

In the communication method provided in the embodiments in the present disclosure, FIG. 8 is a flowchart of another communication method according to an exemplary embodiment. As shown in FIG. 8, determining the transmission mode for the PUCCH in S11 can include the following step S71.

In step S71, based on a predefined rule, the transmission mode of PUCCH is determined.

In some embodiments, the terminal may determine the transmission mode of PUCCH based on the predefined rule.

For example, when the terminal performs random access, the transmission mode for the PUCCH is predefined. If using frequency hopping transmission or non-frequency hopping transmission. The terminal determines the transmission mode of PUCCH based on the predefined transmission mode of PUCCH.

The present disclosure can determine the transmission mode of PUCCH as frequency hopping transmission or non-frequency hopping transmission through the predefined rule, such that terminals can use non-frequency hopping transmission for random access, avoiding resource waste caused by using PUCCH frequency hopping.

In the communication method provided in the embodiments in the present disclosure, the transmission mode of PUCCH defaults to non-frequency hopping transmission.

In some embodiments, when the terminal performs random access, the transmission mode of PUCCH can be set to non-frequency hopping transmission by default.

For example, the terminal can use the default transmission mode (i.e., non-frequency hopping transmission) based on the predefined rule for the PUCCH for random access. For example, when the terminal does not receive the frequency hopping indication information transmitted by the network device, the terminal adopts the default transmission mode for the PUCCH, that is, non hopping transmission, for random access.

The present disclosure can use non-frequency hopping transmission as the default transmission method for PUCCH, such that terminals can use non-frequency hopping transmission for random access, avoiding resource waste caused by using PUCCH frequency hopping.

In the communication method provided in the embodiments in the present disclosure, the operating frequency band meeting the condition may include at least one of the following: the frequency band number of the operating frequency band being n8; the frequency band number of the operating frequency band being n26; the frequency band number of the operating frequency band being n28; or the frequency band number of the operating frequency band being n100.

In some embodiments of the present disclosure, the operating frequency band based on which the terminal performs random access may be the operating frequency band corresponding to the frequency band number n8.

In some embodiments of the present disclosure, the operating frequency band based on which the terminal performs random access may be the operating frequency band corresponding to the frequency band number n26.

In some embodiments of the present disclosure, the operating frequency band based on which the terminal performs random access may be the operating frequency band corresponding to the frequency band number n28.

In some embodiments of the present disclosure, the operating frequency band based on which the terminal performs random access may be the operating frequency band corresponding to the frequency band number n100.

It can be understood that the above is only an exemplary description, and the operating frequency band used by the PUCCH during the random access in the present disclosure can also be selected from any frequency band corresponding to the frequency band number. The specific selection can be made according to the actual situation, which is not limited in the present disclosure.

In the present disclosure, it can be determined whether the transmission mode of PUCCH is frequency hopping transmission or non-frequency hopping transmission when random access is performed on certain specific operating frequency bands, such that the terminal can use non-frequency hopping transmission for random access, avoiding resource waste caused by using PUCCH frequency hopping.

Based on the same concept, the present disclosure further provides a communication method performed by the network device.

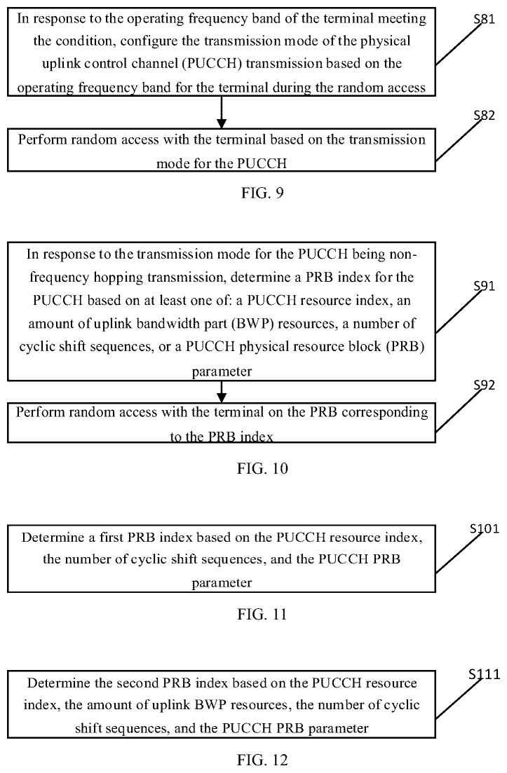

FIG. 9 is a flowchart of another communication method according to an exemplary embodiment. As shown in FIG. 9, the method is performed by the network device and may include the following steps S81 and S82.

In step S81, in response to the operating frequency band of the terminal meeting the condition, the transmission mode of the physical uplink control channel (PUCCH) transmission based on the operating frequency band is configured for the terminal during the random access.

In some embodiments, the network device may configure the transmission mode of PUCCH. The network device can respond to the operating frequency band of the terminal meeting the condition, such as meeting the preset operating frequency band condition. The network device configures the transmission mode for the PUCCH based on the operating frequency band during the random access for the terminal. Where the transmission mode for PUCCH includes frequency hopping transmission or non-frequency hopping transmission.

For example, in response to the operating frequency band of the terminal meeting the condition, the network device configures frequency hopping transmission as the transmission mode for PUCCH transmission based on the operating frequency band during the random access for the terminal.

For example, in response to the operating frequency band of the terminal meeting the condition, the network device configures non-frequency hopping transmission as the transmission mode for PUCCH transmission based on the operating frequency band during the random access for the terminal.

It can be understood that the non-frequency hopping transmission is transmission without frequency hopping or not frequency hopping transmission.

In step S82, random access is performed with the terminal based on the transmission mode for the PUCCH.

In some embodiments, the network device may perform random access with the terminal based on the transmission mode of PUCCH configured in S81.

For example, the network device performing random access with the terminal based on the transmission mode of PUCCH can include using PUCCH to carry HARQ feedback for Msg.4 in 4-step random access, or using PUCCH to carry HARQ feedback in 2-step random access.

The present disclosure determines the transmission mode of PUCCH during the random access in the operating frequency band that meets the condition, in order to select frequency hopping transmission or non-frequency hopping transmission based on the transmission mode of PUCCH. Thus, avoiding resource waste caused by using PUCCH frequency hopping.

In the communication method provided in the embodiments in the present disclosure, FIG. 10 is a flowchart of another communication method according to an exemplary embodiment. As shown in FIG. 10, performing random access with the terminal based on the transmission mode of PUCCH in S82 can include the following steps S91 and S92.

In step S91, in response to the transmission mode for the PUCCH being non-frequency hopping transmission, a PRB index for the PUCCH is determined based on at least one of: a PUCCH resource index, an amount of uplink bandwidth part (BWP) resources, a number of cyclic shift sequences, or a PUCCH physical resource block (PRB) parameter; and

In some embodiments, in response to the transmission mode for the PUCCH being non-frequency hopping transmission, the network device may determine the PRB index for the PUCCH based on at least one of the PUCCH resource index, the amount of uplink BWP resources, the number of cyclic shift sequences, or the PUCCH PRB parameter.

In step S92, random access is performed with the terminal on the PRB corresponding to the PRB index.

In some embodiments, the network device performs random access with the terminal on the PRB corresponding to the PRB index determined in S91.

When using non-frequency hopping transmission for the PUCCH, the PRB index can be determined by the PUCCH resource index, the amount of uplink BWP resources, the number of cyclic shift sequences, and the PUCCH PRB parameter, such that the network device can use non-frequency hopping transmission for random access with the terminal, avoiding resource waste caused by using PUCCH frequency hopping.

In the communication method provided in the embodiments in the present disclosure, the PUCCH resource index is determined based on the parameter of the PDCCH used in the random access.

In some embodiments, the PUCCH resource index may be determined by the relevant parameters of the PDCCH for scheduling data.

The present disclosure determines the PUCCH resource index through the relevant parameters of the PDCCH, in order to determine the PRB index based on the PUCCH resource index, such that the network device can use non-frequency hopping transmission for random access with the terminal, avoiding resource waste caused by using PUCCH frequency hopping.

In the communication method provided in the embodiments in the present disclosure, the parameters of the PDCCH may include at least one of the following: control channel element CCE information occupied by the PDCCH; the PUCCH resource allocation information contained in the PDCCH.

In some embodiments, the parameter of the PDCCH may include CCE information occupied by the PDCCH.

For example, the network device can determine the PUCCH resource index based on the CCE information occupied by the PDCCH.

In some embodiments, the parameters of the PDCCH may include the PUCCH resource allocation information contained in the PDCCH.

For example, the network device can determine the PUCCH resource index based on the PUCCH resource allocation information contained in the PDCCH.

In some embodiments, the parameters of the PDCCH may include CCE information occupied by the PDCCH and PUCCH resource allocation information contained in the PDCCH.

For example, the network device can determine the PUCCH resource index based on the CCE information occupied by the PDCCH and the PUCCH resource allocation information contained in the PDCCH.

The present disclosure determines the PUCCH resource index based on the CCE information occupied by the PDCCH and/or the PUCCH resource allocation information contained in the PDCCH, in order to determine the PRB index based on the PUCCH resource index, such that the network device can use non-frequency hopping transmission for random access with the terminal, avoiding resource waste caused by using PUCCH frequency hopping.

In the communication method provided in the embodiments in the present disclosure, one or more of the amount of uplink BWP resources, the number of cyclic shift sequences, or the PUCCH PRB parameter are configured based on higher-layer signaling from the network device.

In some embodiments, the amount of uplink BWP resources can be configured by higher-layer signaling from the network device.

In some embodiments, the number of cyclic shift sequences can be configured by higher-layer signaling from the network device.

In some embodiments, PUCCH PRB parameter can be configured by higher-layer signaling from the network device.

In some embodiments, the higher-layer signaling can be configured based on the parameters shown in table 1.

In some embodiments, the higher-layer signaling can be configured based on the parameters shown in table 2.

The present disclosure configures one or more of the amount of uplink BWP resources, the number of cyclic shift sequences, and PUCCH PRB parameters through higher-layer signaling to determine the PRB index, such that the network device can use non-frequency hopping transmission for random access with the terminal, avoiding resource waste caused by using PUCCH frequency hopping.

In the communication method provided in the embodiments in the present disclosure, FIG. 11 is a flowchart of another communication method according to an exemplary embodiment. As shown in FIG. 11, in S21, determining the PRB index for the PUCCH based on at least one of: a PUCCH resource index, an amount of uplink bandwidth part (BWP) resources, a number of cyclic shift sequences, or a PUCCH physical resource block (PRB) parameter may include the following step S101.

In step S101, a first PRB index is determined based on the PUCCH resource index, the number of cyclic shift sequences, and the PUCCH PRB parameter.

In some embodiments, the network device may determine the first PRB index based on the PUCCH resource index, the number of cyclic shift sequences, and the PUCCH PRB parameter.

For example, the network device can determine the first PRB index using the method shown in formula 1.

The present disclosure can determine the PRB index through the PUCCH resource index, the number of cyclic shift sequences, and the PUCCH PRB parameters, such that the network device can use non-frequency hopping transmission for random access with the terminal, avoiding resource waste caused by using PUCCH frequency hopping.

In the communication method provided in the embodiments in the present disclosure, FIG. 12 is a flowchart of another communication method according to an exemplary embodiment. As shown in FIG. 12, in S21, determining the PRB index for the PUCCH based on at least one of: a PUCCH resource index, an amount of uplink bandwidth part (BWP) resources, a number of cyclic shift sequences, or a PUCCH physical resource block (PRB) parameter may include the following step S111.

In step S111, the second PRB index is determined based on the PUCCH resource index, the amount of uplink BWP resources, the number of cyclic shift sequences, and the PUCCH PRB parameter.

In some embodiments, the network device may determine the second PRB index based on the PUCCH resource index, the amount of uplink BWP resources, number of cyclic shift sequences, and PUCCH PRB parameters.

For example, the network device can determine the second PRB index using the method shown in formula 2.

In the present disclosure, the PRB index can be determined through the PUCCH resource index, the amount of uplink BWP resources, the number of cyclic shift sequences, and the PUCCH PRB parameters, such that the network device can use non-frequency hopping transmission for random access with the terminal, avoiding resource waste caused by using PUCCH frequency hopping.

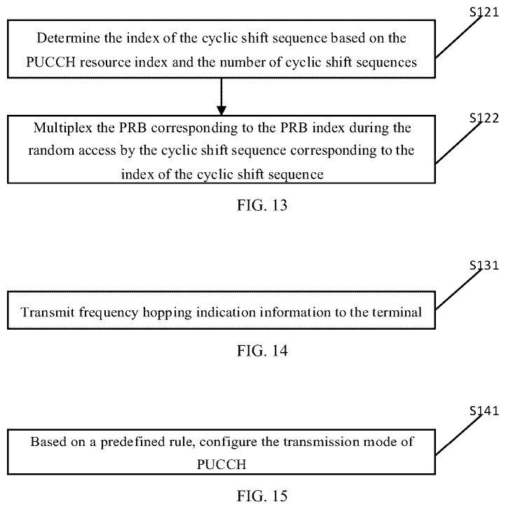

In the communication method provided in the embodiments in the present disclosure, FIG. 13 is a flowchart of another communication method according to an exemplary embodiment. As shown in FIG. 13, S22, performing the random access with the terminal on a PRB corresponding to the PRB index can include the following steps S121 to S122.

In step S121, the index of the cyclic shift sequence is determined based on the PUCCH resource index and the number of cyclic shift sequences.

In some embodiments, the network device may determine the index of the cyclic shift sequence based on the PUCCH resource index and the number of cyclic shift sequences. Where the cyclic shift sequence corresponding to the index of the cyclic shift sequence is for multiplexing of the PRB corresponding to the PRB index.

For example, the network device can determine the index of the cyclic shift sequence based on r_{PUCCH} and N_{CS}.

In step S122, the PRB corresponding to the PRB index is multiplexed during the random access by the cyclic shift sequence corresponding to the index of the cyclic shift sequence.

In some embodiments, the network device may multiplex the PRB corresponding to the PRB index during the random access by the cyclic shift sequence corresponding to the index of the cyclic shift sequence determined in S121. It can be understood that PRB can be multiplexed based on the code domain to form orthogonality between the multiplexed PRB and avoid signal interference.

The present disclosure achieves PRB multiplexing by determining the index of the cyclic shift sequence, such that the network device can use non-frequency hopping transmission for random access with the terminal, avoiding resource waste caused by using PUCCH frequency hopping.

In the communication method provided in the embodiments in the present disclosure, the index of the cyclic shift sequence is equal to the PUCCH resource index modulo the number of cyclic shift sequences.

In some embodiments, the network device may determine the index of the cyclic shift sequence by the PUCCH resource index modulo the number of cyclic shift sequences. For example, it can be determined through formula 3.

In the present disclosure, the index of the cyclic shift sequence is determined by taking the modulo to achieve multiplexing of PRB, such that the network device can use non-frequency hopping transmission for random access with the terminal, avoiding resource waste caused by using PUCCH frequency hopping.

In the communication method provided in the embodiments in the present disclosure, FIG. 14 is a flowchart of another communication method according to an exemplary embodiment. As shown in FIG. 14, the method may further include the following step S131.

In step S131, frequency hopping indication information is transmitted to the terminal.

In some embodiments, the network device may transmit frequency hopping indication information to the terminal. Where the frequency hopping indication information is configured to indicate whether the transmission mode of PUCCH is frequency hopping transmission or non-frequency hopping transmission.

For example, the network device can transmit system information to the terminal, where the system information carries the frequency hopping indication information. The frequency hopping indication information can notify whether the transmission mode for the PUCCH during the random access is frequency hopping transmission or non-frequency hopping transmission, such that the terminal can determine whether the transmission mode of PUCCH is frequency hopping transmission or non-frequency hopping transmission based on the received frequency hopping indication information.

In the present disclosure, the frequency hopping indication information transmitted by the network device can indicate whether the transmission mode of PUCCH is frequency hopping transmission or non-frequency hopping transmission, such that non-frequency hopping transmission can be flexibly configured for random access, avoiding resource waste caused by using PUCCH frequency hopping.

In the communication method provided in the embodiments in the present disclosure, the frequency hopping indication information includes a PRB index indicator. Where the PRB index indicator indicates whether a PRB used for the random access is a PRB corresponding to a first PRB index or a PRB corresponding to a second PRB index.

In some embodiments, the frequency hopping indication information may include a PRB index indicator. The PRB index indicator indicates whether a PRB used for the random access is a PRB corresponding to a first PRB index or a PRB corresponding to a second PRB index.

For example, the PRB index indicator being a first preset value can indicate that the PRB used during the random access is the PRB corresponding to the first PRB index. The first PRB index can be determined using the method shown in formula 1, and during the random access, the corresponding PRB can be found using the first PRB index for the random access.

For example, the PRB index indicator being the second preset value can indicate that the PRB used during the random access is the PRB corresponding to the second PRB index. The second PRB index can be determined using the method shown in formula 2, and during the random access, the corresponding PRB can be found using the second PRB index for the random access.

The present disclosure uses a PRB index indicator to indicate the PRB used for random access, such that the network device can use non-frequency hopping transmission for random access with the terminal, avoiding resource waste caused by using PUCCH frequency hopping.

In the communication method provided in the embodiments in the present disclosure, FIG. 15 is a flowchart of another communication method according to an exemplary embodiment. As shown in FIG. 15, S81, configuring the transmission mode for the PUCCH by which the terminal performs PUCCH transmission based on the operating frequency band during the random access can include the following step S141.

In step S141, based on a predefined rule, the transmission mode of PUCCH is configured.

In some embodiments, the network device may configure the transmission mode of PUCCH based on the predefined rule.

For example, when the terminal performs random access, the transmission mode for the PUCCH is predefined. If using frequency hopping transmission or non-frequency hopping transmission. The network device configures the transmission mode of PUCCH based on the predefined transmission mode of PUCCH.

The present disclosure can configure the transmission mode of PUCCH as frequency hopping transmission or non-frequency hopping transmission through the predefined rule, such that network device can use non-frequency hopping transmission for random access with the terminal, avoiding resource waste caused by using PUCCH frequency hopping.

In the communication method provided in the embodiments in the present disclosure, the transmission mode of PUCCH defaults to non-frequency hopping transmission.

In some embodiments, when the network device performs random access with the terminal, the transmission mode of PUCCH can be set to non-frequency hopping transmission by default.

For example, the network device can use the default transmission mode (i.e., non-frequency hopping transmission) based on the predefined rule for the PUCCH for random access with the terminal. For example, when the network device does not transmit frequency hopping indication information, the default transmission mode for the PUCCH is adopted, that is, non-frequency hopping transmission is adopted for random access with the terminal.

In the present disclosure, by configuring non-frequency hopping transmission as the default transmission mode of PUCCH, the network device can use non-frequency hopping transmission by default to perform random access with the terminal, avoiding resource waste caused by using PUCCH frequency hopping.

In the communication method provided in the embodiments in the present disclosure, the operating frequency band meeting the condition may include at least one of the following: the frequency band number of the operating frequency band being n8; the frequency band number of the operating frequency band being n26; the frequency band number of the operating frequency band being n28; or the frequency band number of the operating frequency band being n100.

In some embodiments of the present disclosure, the operating frequency band based on which the terminal performs random access may be the operating frequency band corresponding to the frequency band number n8.

In some embodiments of the present disclosure, the operating frequency band based on which the terminal performs random access may be the operating frequency band corresponding to the frequency band number n26.

In some embodiments of the present disclosure, the operating frequency band based on which the terminal performs random access may be the operating frequency band corresponding to the frequency band number n28.

In some embodiments of the present disclosure, the operating frequency band based on which the terminal performs random access may be the operating frequency band corresponding to the frequency band number n100.

It can be understood that the above is only an exemplary description, and the operating frequency band used by the PUCCH during the random access in the present disclosure can also be selected from any frequency band corresponding to the frequency band number. The specific selection can be made according to the actual situation, which is not limited in the present disclosure.

In the present disclosure, it can be determined whether the transmission mode of PUCCH is frequency hopping transmission or non-frequency hopping transmission when random access is performed on certain specific operating frequency bands, such that the network device can use non-frequency hopping transmission for random access with the terminal, avoiding resource waste caused by using PUCCH frequency hopping.

It can be understood that the specific implementation process of the methods described in FIGS. 9 to 15 can refer to the corresponding descriptions in FIGS. 2 to 8, and will not be repeated in the present disclosure.

It should be noted that those skilled in the art can understand that the various embodiments/implementations mentioned in the present disclosure can be used in conjunction with the aforementioned embodiments or used independently. Whether used independently or in conjunction with the aforementioned embodiments, the implementation principle is similar. In the embodiments of the present disclosure, some embodiments are described as being used together. Of course, those skilled in the art can understand that such examples do not limit the embodiments of the present disclosure.

Based on the same concept, the embodiments in the present disclosure further provide communication apparatuses and devices.

It can be understood that the communication apparatuses and devices provided in the embodiments in the present disclosure include hardware structures and/or software modules corresponding to the execution of various functions in order to achieve the above functions. Based on the units and algorithm steps of the examples in the present disclosure, the present disclosure can be implemented in the form of hardware or a combination of hardware and computer software. Whether a certain function is executed through hardware or computer software driven hardware depends on the specific application and design constraints of the technical solution. Those skilled in the art can use different methods to achieve the described functions for each specific application, but such implementation should not be considered beyond the scope of the technical solutions in the embodiments in the present disclosure.

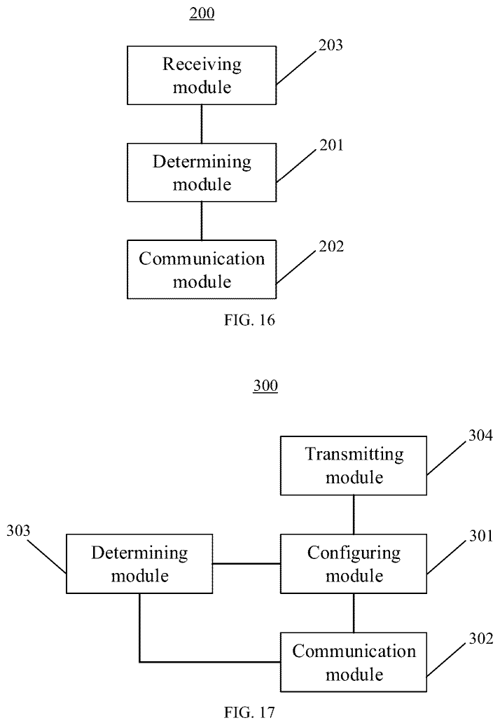

FIG. 16 is a schematic diagram of a communication apparatus according to an exemplary embodiment. Referring to FIG. 16, apparatus 200 is configured in a terminal. The apparatus 200 includes: a determining module 201, configured to, in response to an operating frequency band of the terminal meeting a condition, and the terminal performing PUCCH transmission based on the operating frequency band during random access, determine a transmission mode for the PUCCH, where the transmission mode for the PUCCH includes frequency hopping transmission or non-frequency hopping transmission; and a communication module 202, configured to perform random access based on the determined transmission mode of PUCCH.

The present disclosure determines the transmission mode of PUCCH during the random access in the operating frequency band that meets the condition, in order to select frequency hopping transmission or non-frequency hopping transmission based on the transmission mode of PUCCH. Thus, avoiding resource waste caused by using PUCCH frequency hopping.

In an embodiment, the determining module 201 is further configured to, in response to the transmission mode for the PUCCH being non-frequency hopping transmission, determine a PRB index for the PUCCH based on at least one of: a PUCCH resource index, an amount of uplink bandwidth part (BWP) resources, a number of cyclic shift sequences, or a PUCCH physical resource block (PRB) parameter; and the communication module 202 is further configured to perform random access on the PRB corresponding to the PRB index.

When using non-frequency hopping transmission for the PUCCH, the PRB index can be determined by the PUCCH resource index, the amount of uplink BWP resources, the number of cyclic shift sequences, and the PUCCH PRB parameter, such that the terminal can use non-frequency hopping transmission for random access, avoiding resource waste caused by using PUCCH frequency hopping.

In an embodiment, the PUCCH resource index is determined based on a parameter of a physical downlink control channel (PDCCH) used in the random access.

The present disclosure determines the PUCCH resource index through the relevant parameters of the PDCCH, in order to determine the PRB index based on the PUCCH resource index, such that the terminal can use non-frequency hopping transmission for random access, avoiding resource waste caused by using PUCCH frequency hopping.

In an embodiment, the parameter of the PDCCH includes at least one of: control channel element (CCE) information occupied by the PDCCH; or PUCCH resource allocation information contained in the PDCCH.

The present disclosure determines the PUCCH resource index based on the CCE information occupied by the PDCCH and/or the PUCCH resource allocation information contained in the PDCCH, in order to determine the PRB index based on the PUCCH resource index, such that the terminal can use non-frequency hopping transmission for random access, avoiding resource waste caused by using PUCCH frequency hopping.

In an embodiment, one or more of the amount of uplink BWP resources, the number of cyclic shift sequences, or the PUCCH PRB parameter are configured based on higher-layer signaling transmitted by a network device.

The present disclosure configures one or more of the amount of uplink BWP resources, the number of cyclic shift sequences, and PUCCH PRB parameters through higher-layer signaling to determine the PRB index, such that the terminal can use non-frequency hopping transmission for random access, avoiding resource waste caused by using PUCCH frequency hopping.

In an embodiment, the determining module 201 is further configured to determine the first PRB index based on the PUCCH resource index, the number of cyclic shift sequences, and the PUCCH PRB parameter.

The present disclosure can determine the PRB index through the PUCCH resource index, the number of cyclic shift sequences, and the PUCCH PRB parameters, such that the terminal can use non-frequency hopping transmission for random access, avoiding resource waste caused by using PUCCH frequency hopping.

In an embodiment, the determining module 201 is further configured to determine the second PRB index based on the PUCCH resource index, the amount of uplink BWP resources, number of cyclic shift sequences, and PUCCH PRB parameters.

In the present disclosure, the PRB index can be determined through the PUCCH resource index, the amount of uplink BWP resources, the number of cyclic shift sequences, and the PUCCH PRB parameters, such that the terminal can use non-frequency hopping transmission for random access, avoiding resource waste caused by using PUCCH frequency hopping.

In an embodiment, the determining module 201 is further configured to determine an index of a cyclic shift sequence based on the PUCCH resource index and the number of cyclic shift sequences, where a cyclic shift sequence corresponding to the index of the cyclic shift sequence is for multiplexing the PRB corresponding to the PRB index; and the communication module 202 is further configured to multiplex the PRB corresponding to the PRB index during the random access by the cyclic shift sequence corresponding to the index of the cyclic shift sequence.

The present disclosure achieves PRB multiplexing by determining the index of the cyclic shift sequence, such that the terminal can use non-frequency hopping transmission for random access, avoiding resource waste caused by using PUCCH frequency hopping.

In an embodiment, the index of the cyclic shift sequence is equal to the PUCCH resource index modulo the number of cyclic shift sequences.

In the present disclosure, the index of the cyclic shift sequence is determined by taking the modulo to achieve multiplexing of PRB, such that the terminal can use non-frequency hopping transmission for random access, avoiding resource waste caused by using PUCCH frequency hopping.

In an embodiment, apparatus 200 further includes a receiving module 203 configured to receive frequency hopping indication information transmitted by a network device, where the frequency hopping indication information is configured to indicate whether the transmission mode for the PUCCH is frequency hopping transmission or non-frequency hopping transmission; and the determining module 201 is further configured to determine the transmission mode for the PUCCH based on the frequency hopping indication information.

In the present disclosure, the frequency hopping indication information transmitted by the network device can indicate whether the transmission mode of PUCCH is frequency hopping transmission or non-frequency hopping transmission, such that the terminal can flexibly use non-frequency hopping transmission for random access, avoiding resource waste caused by using PUCCH frequency hopping.

In an embodiment, the frequency hopping indication information includes a PRB index indicator; and the PRB index indicator indicates whether a PRB used for the random access is a PRB corresponding to a first PRB index or a PRB corresponding to a second PRB index.

The present disclosure uses a PRB index indicator to indicate the PRB used for random access, such that the terminal can use non-frequency hopping transmission for random access, avoiding resource waste caused by using PUCCH frequency hopping.

In an embodiment, the determining module 201 is further configured to determine the transmission mode for the PUCCH based on a predefined rule.

The present disclosure can determine the transmission mode of PUCCH as frequency hopping transmission or non-frequency hopping transmission through the predefined rule, such that terminals can use non-frequency hopping transmission for random access, avoiding resource waste caused by using PUCCH frequency hopping.

In an embodiment, the transmission mode of PUCCH defaults to non-frequency hopping transmission.

The present disclosure can use non-frequency hopping transmission as the default transmission method for PUCCH, such that terminals can use non-frequency hopping transmission for random access, avoiding resource waste caused by using PUCCH frequency hopping.

In an embodiment, the operating frequency band meeting the condition includes at least one of: a frequency band number of the operating frequency band is n8; a frequency band number of the operating frequency band is n26; a frequency band number of the operating frequency band is n28; or a frequency band number of the operating frequency band is n100.

In the present disclosure, it can be determined whether the transmission mode of PUCCH is frequency hopping transmission or non-frequency hopping transmission when random access is performed on certain specific operating frequency bands, such that the terminal can use non-frequency hopping transmission for random access, avoiding resource waste caused by using PUCCH frequency hopping.

FIG. 17 is a schematic diagram of a communication apparatus according to an exemplary embodiment. Referring to FIG. 17, apparatus 300 is configured in a network device, where the apparatus 300 includes a configuration module 301 configured to, in response to an operating frequency band of a terminal meeting a condition, configure a transmission mode for a physical uplink control channel (PUCCH) by which the terminal performs PUCCH transmission based on the operating frequency band during random access, where the transmission mode for the PUCCH includes frequency hopping transmission or non-frequency hopping transmission; and a communication module 302 configured to perform random access with the terminal based on the transmission mode for the PUCCH.

The present disclosure determines the transmission mode of PUCCH during the random access in the operating frequency band that meets the condition, in order to select frequency hopping transmission or non-frequency hopping transmission based on the transmission mode of PUCCH. Thus, avoiding resource waste caused by using PUCCH frequency hopping.

In an embodiment, the apparatus 300 further includes a determining module 303, configured to, in response to the transmission mode for the PUCCH being non-frequency hopping transmission, determine a PRB index for the PUCCH based on at least one of: a PUCCH resource index, an amount of uplink bandwidth part (BWP) resources, a number of cyclic shift sequences, or a PUCCH physical resource block (PRB) parameter; and the communication module 302 is further configured to perform the random access with the terminal on a PRB corresponding to the PRB index.

When using non-frequency hopping transmission for the PUCCH, the PRB index can be determined by the PUCCH resource index, the amount of uplink BWP resources, the number of cyclic shift sequences, and the PUCCH PRB parameter, such that the network device can use non-frequency hopping transmission for random access with the terminal, avoiding resource waste caused by using PUCCH frequency hopping.

In an embodiment, the PUCCH resource index is determined based on a parameter of a physical downlink control channel (PDCCH) used in the random access.

The present disclosure determines the PUCCH resource index through the relevant parameters of the PDCCH, in order to determine the PRB index based on the PUCCH resource index, such that the network device can use non-frequency hopping transmission for random access with the terminal, avoiding resource waste caused by using PUCCH frequency hopping.

In an embodiment, the parameter of the PDCCH includes at least one of: control channel element (CCE) information occupied by the PDCCH; or PUCCH resource allocation information contained in the PDCCH.

The present disclosure determines the PUCCH resource index based on the CCE information occupied by the PDCCH and/or the PUCCH resource allocation information contained in the PDCCH, in order to determine the PRB index based on the PUCCH resource index, such that the network device can use non-frequency hopping transmission for random access with the terminal, avoiding resource waste caused by using PUCCH frequency hopping.

In an embodiment, one or more of the amount of uplink BWP resources, the number of cyclic shift sequences, or the PUCCH PRB parameters are configured based on higher-layer signaling from the network device.

In the present disclosure, one or more of the amount of uplink BWP resources, the number of cyclic shift sequences, and PUCCH PRB parameters are configured through higher-layer signaling to determine the PRB index, such that the network device can use non-frequency hopping transmission for random access with the terminal, avoiding resource waste caused by using PUCCH frequency hopping.

In an embodiment, the determining module 303 is further configured to determine the first PRB index based on the PUCCH resource index, the number of cyclic shift sequences, and the PUCCH PRB parameter.

The present disclosure can determine the PRB index through the PUCCH resource index, the number of cyclic shift sequences, and the PUCCH PRB parameters, such that the network device can use non-frequency hopping transmission for random access with the terminal, avoiding resource waste caused by using PUCCH frequency hopping.

In an embodiment, the determining module 303 is further configured to determine the second PRB index based on the PUCCH resource index, the amount of uplink BWP resources, number of cyclic shift sequences, and PUCCH PRB parameters.

In the present disclosure, the PRB index can be determined through the PUCCH resource index, the amount of uplink BWP resources, the number of cyclic shift sequences, and the PUCCH PRB parameters, such that the network device can use non-frequency hopping transmission for random access with the terminal, avoiding resource waste caused by using PUCCH frequency hopping.

In an embodiment, the determining module 303 is further configured to determine an index of a cyclic shift sequence based on the PUCCH resource index and the number of cyclic shift sequences, where a cyclic shift sequence corresponding to the index of the cyclic shift sequence is for multiplexing the PRB corresponding to the PRB index; and the communication module 302 is further configured to multiplex the PRB corresponding to the PRB index during the random access by the cyclic shift sequence corresponding to the index of the cyclic shift sequence.

The present disclosure achieves PRB multiplexing by determining the index of the cyclic shift sequence, such that the network device can use non-frequency hopping transmission for random access with the terminal, avoiding resource waste caused by using PUCCH frequency hopping.

In an embodiment, the index of the cyclic shift sequence is equal to the PUCCH resource index modulo the number of cyclic shift sequences.

In the present disclosure, the index of the cyclic shift sequence is determined by taking the modulo to achieve multiplexing of PRB, such that the network device can use non-frequency hopping transmission for random access with the terminal, avoiding resource waste caused by using PUCCH frequency hopping.

In an embodiment, the apparatus 300 further includes a transmitting module 304 configured to transmit frequency hopping indication information to the terminal, where the frequency hopping indication information is configured to indicate whether the transmission mode is frequency hopping transmission or non-frequency hopping transmission.

In the present disclosure, the frequency hopping indication information transmitted by the network device can indicate whether the transmission mode of PUCCH is frequency hopping transmission or non-frequency hopping transmission, such that non-frequency hopping transmission can be flexibly configured for random access, avoiding resource waste caused by using PUCCH frequency hopping.

In an embodiment, the frequency hopping indication information includes a PRB index indicator; and the PRB index indicator indicates whether a PRB used for the random access is a PRB corresponding to a first PRB index or a PRB corresponding to a second PRB index.

The present disclosure uses a PRB index indicator to indicate the PRB used for random access, such that the network device can use non-frequency hopping transmission for random access with the terminal, avoiding resource waste caused by using PUCCH frequency hopping.

In an embodiment, the configuring module 301 is further configured to configure the transmission mode of PUCCH based on the predefined rule.

The present disclosure can configure the transmission mode of PUCCH as frequency hopping transmission or non-frequency hopping transmission through the predefined rule, such that network device can use non-frequency hopping transmission for random access with the terminal, avoiding resource waste caused by using PUCCH frequency hopping.

In an embodiment, the transmission mode of PUCCH defaults to non-frequency hopping transmission.

In the present disclosure, by configuring non-frequency hopping transmission as the default transmission mode of PUCCH, the network device can use non-frequency hopping transmission by default to perform random access with the terminal, avoiding resource waste caused by using PUCCH frequency hopping.

In an embodiment, the operating frequency band meeting the condition includes at least one of: a frequency band number of the operating frequency band is n8; a frequency band number of the operating frequency band is n26; a frequency band number of the operating frequency band is n28; or a frequency band number of the operating frequency band is n100.

In the present disclosure, it can be determined whether the transmission mode of PUCCH is frequency hopping transmission or non-frequency hopping transmission when random access is performed on certain specific operating frequency bands, such that the network device can use non-frequency hopping transmission for random access with the terminal, avoiding resource waste caused by using PUCCH frequency hopping.

Regarding the apparatuses 200 and 300 in the above examples, the specific manner in which each module performs operations has been described in detail in the examples of the methods, and will not be described in detail here.

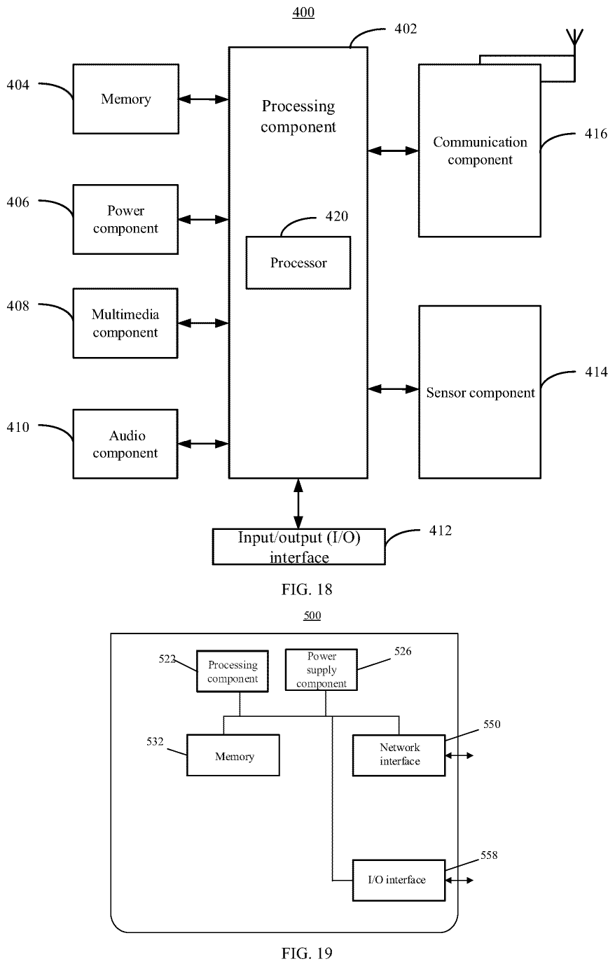

FIG. 18 is a schematic diagram of a communication device according to an exemplary embodiment. For example, the electronic device 400 may be a mobile phone, a computer, a digital broadcast terminal, a message transceiving device, a game console, a tablet device, a medical device, a fitness device and a personal digital assistant and so on.

Referring to FIG. 18, the electronic device 400 may include one or more of the following components: a processing component 402, a memory 404, a power supply component 406, a multimedia component 408, an audio component 410, an input/output (I/O) interface 412, a sensor component 414, and a communication component 416.

The processing component 402 generally controls the overall operation of the electronic device 400, such as operations associated with displays, phone calls, data communications, camera operations, and recording operations. The processing component 402 may include one or more processors 420 to execute instructions to complete all or a part of the blocks of the above methods. Further, the processing component 402 may include one or more modules to facilitate interaction between the processing component 402 and another component. For example, the processing component 402 may include a multimedia module to facilitate the interaction between the multimedia component 408 and the processing component 402.

The memory 404 is configured to store different types of data to support operations at the electronic device 400. Examples of such data include instructions of any application program or method operable on the electronic device 400, contact data, telephone directory data, messages, pictures, videos, and the like. The memory 404 may be implemented by any type of volatile or non-volatile storage devices or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a disk or a CD.

The power supply component 406 provides power for different components of the electronic device 400. The power supply component 406 may include a power management system, one or more power sources, and other components associated with generating, managing and distributing power for the electronic device 400.

The multimedia component 408 may include a screen for providing an output interface between the electronic device 400 and a user. In some examples, the screen may include a Liquid Crystal Display (LCD) and a touch Panel (TP). If the screen includes a touch panel, the screen may be implemented as a touch screen for receiving an input signaling from a user. The touch panel may include one or more touch sensors for sensing a touch, a slide and a gesture on the touch panel. The touch sensor may not only sense a boundary of a touching or sliding movement, but also detect duration and pressure related to the touching or sliding operation. In some examples, the multimedia component 408 may include a front camera and/or a rear camera. When the electronic device 400 is in an operation mode, such as a shooting mode or a video mode, the front camera and/or the rear camera may receive external multimedia data. Each of the front camera and the rear camera may be a fixed optical lens system or be of a focal length and a capability of an optical zoom.

The audio component 410 is configured to output and/or input an audio signaling. For example, the audio component 410 may include a microphone (MIC). When the electronic device 400 is in an operating mode, such as a call mode, a recording mode and a speech recognition mode, the microphone is configured to receive an external audio signal. The received audio signaling may be further stored in the memory 404 or transmitted via the communication component 416. In some examples, the audio component 410 also includes a loudspeaker for outputting an audio signaling.

The I/O interface 412 may provide an interface between the processing component 402 and peripheral interface modules. The above peripheral interface modules may include a keyboard, a click wheel, buttons and so on. These buttons may include but not limited to, a home button, a volume button, a start button and a lock button.

The sensor component 414 may include one or more sensors for providing state assessments in different aspects for the electronic device 400. For example, the sensor component 414 may detect the on/off state of the electronic device 400, and relative locations of components, such as a display and a small keyboard of the electronic device 400. The sensor component 414 may also detect a position change of the electronic device 400 or a component of the electronic device 400, the presence or absence of contact of a user with the electronic device 400, an orientation or acceleration/deceleration of the electronic device 400 and a temperature change of the electronic device 400. The sensor component 414 may include a proximity sensor for detecting the existence of a nearby object without any physical touch. The sensor component 414 may also include an optical sensor, such as a CMOS or CCD image sensor used in an imaging application. In some examples, the sensor component 414 may also include an acceleration sensor, a gyro sensor, a magnetic sensor, a pressure sensor, or a temperature sensor.

The communication component 416 is configured to facilitate wired or wireless communication between the electronic device 400 and other devices. The electronic device 400 may access a wireless network based on a communication standard, such as WIFI, 2G or 3G, or a combination thereof. In some embodiments, the communication component 416 may receive a broadcast signaling or broadcast-related information from an external broadcast management system via a broadcast channel. In an example, the communication component 416 may also include a Near Field Communication (NFC) module to facilitate short-range communications. For example, the NFC module may be implemented based on a Radio Frequency Identification (RFID) technology, an Infrared Data Association (IrDA) technology, an Ultra Wideband (UWB) technology, a Bluetooth® (BT) technology and other technologies.

In an example, the electronic device 400 may be implemented by one or more of an Application Specific Integrated Circuit (ASIC), a Digital Signal Processor (DSP), a Digital Signal Processor (DSPD), a Programmable Logic Device (PLD), a Field Programmable Gate Array (FPGA), a controller, a microcontroller, a microprocessor or other electronic components to perform the above method.

In an example, a non-transitory machine readable storage medium storing machine executable instructions is provided, such as the memory 404 storing instructions. The instructions may cause the processor 420 in the electronic device 400 to perform the above method. For example, the non-transitory computer-readable storage medium may be a ROM, a RAM, a CD-ROM, a magnetic tape, a floppy disc, an optical data storage device, and the like.

FIG. 19 is a schematic diagram of a communication device according to an exemplary embodiment. For example, the device 500 may be provided as a base station or a server. Referring to FIG. 19, the device 500 includes a processing component 522, which further includes one or more processors, and a memory resource represented by a memory 532 for storing instructions, such as applications, that can be executed by the processing component 522. The application stored in the memory 532 may include one or more modules and each module corresponds to a set of instructions. In addition, the processing component 522 is configured to execute instructions to execute the method mentioned above.

The device 500 may also include a power supply component 526 configured to perform power management of the device 500, a wired or wireless network interface 550 configured to connect the device 500 to the network, and an input-output (I/O) interface 558. The device 500 can operate an operating system stored in the memory 532, such as Windows Server™, Mac OS X™, Unix™, Linux™, FreeBSD™ or the like.

The present disclosure determines the transmission mode of PUCCH during the random access in the operating frequency band that meets the condition, in order to select frequency hopping transmission or non-frequency hopping transmission based on the transmission mode of PUCCH. Thus avoiding resource waste caused by using PUCCH frequency hopping.

The present disclosure provides a transmission method for the PUCCH on a special dedicated frequency band, avoiding the waste of transmission resources in small bandwidth scenarios.

It can be understood that in the present disclosure, “a plurality of” refers to two or more, similar to other quantifiers. The term “and/or” is only a description of the association relationship of associated objects, indicating that there can be three types of relationships, such as, A and/or B can represent three situations of A alone, A and B simultaneously, and B alone. The character “/” generally indicates that the associated objects before and after “/” are in an “or” relationship. The singular forms “a”, “an” and “the” are intended to include the plural forms as well, unless the context clearly indicates otherwise.

It can be understood that the terms “first”, “second”, etc. are used to describe various information, but these information should not be limited to these terms. These terms are only used to distinguish one category of information from another, and do not indicate a specific order or level of importance. In fact, expressions such as “first” and “second” can be used interchangeably. For example, without departing from the scope of the present disclosure, the first information may also be referred to as the second information, and similarly, the second information may also be referred to as the first information.

It can be further understood that the meanings of words such as “in response to” and “if” mentioned in the present disclosure depend on the context and the actual usage scenario. For example, the word “in response to” used here can be interpreted as “when” or “where” or “if”.

It can be further understood that although the operations are described in a specific order in the accompanying drawings in the embodiments in the present disclosure, it should not be understood as requiring the execution of these operations in the specific order or serial order shown, or requiring the execution of all the operations shown to achieve the desired results. In some implementations, multitasking and parallel processing may be advantageous.

Other implementations of the present disclosure will be apparent to those skilled in the art from consideration of the specification and practice of the present disclosure herein. The present disclosure is intended to cover any modification, use or adaptation of the present disclosure. These modifications, uses or adaptations follow the general principles of the present disclosure and include common knowledge and conventional technical means in the technical field that are not disclosed in the present disclosure.

It is to be understood that the present disclosure is not limited to the precise structures described above and shown in the accompanying drawings and may be modified or changed without departing from the scope of the present disclosure. The scope of the present disclosure is limited only by the scope of the claims attached.

1. A method for wireless communication performed by a terminal, the method comprising:
in response to an operating frequency band of the terminal meeting a condition, and the terminal performing physical uplink control channel (PUCCH) transmission based on the operating frequency band during random access, determining a transmission mode for a PUCCH, wherein the transmission mode for the PUCCH comprises frequency hopping transmission or non-frequency hopping transmission; and
performing random access based on the determined transmission mode for the PUCCH.

2. The method according to claim 1, wherein performing the random access based on the determined transmission mode for the PUCCH comprises:
in response to the transmission mode for the PUCCH being non-frequency hopping transmission, determining a physical resource block (PRB) index for the PUCCH based on at least one of: a PUCCH resource index, an amount of uplink bandwidth part (BWP) resources, a number of cyclic shift sequences, or a PUCCH PRB parameter; and
performing the random access on a PRB corresponding to the PRB index.

3. The method according to claim 2, wherein the PUCCH resource index is determined based on a parameter of a physical downlink control channel (PDCCH) used in the random access.

4. The method according to claim 3, wherein the parameter of the PDCCH comprises at least one of:
control channel element (CCE) information occupied by the PDCCH; or
PUCCH resource allocation information contained in the PDCCH.

5. The method according to claim 2, wherein one or more of the amount of uplink BWP resources, the number of the cyclic shift sequences, or the PUCCH PRB parameter are configured based on higher-layer signaling transmitted by a network device.

6. The method according to claim 2, wherein determining the PRB index for the PUCCH based on at least one of: the PUCCH resource index, the amount of uplink BWP resources, the number of the cyclic shift sequences, or the PUCCH PRB parameter comprises:
determining a first PRB index based on the PUCCH resource index, the number of the cyclic shift sequences, and the PUCCH PRB parameter.

7. The method according to claim 2, wherein determining the PRB index for the PUCCH based on at least one of: the PUCCH resource index, the amount of uplink BWP resources, the number of the cyclic shift sequences, or the PUCCH PRB parameter comprises:
determining a second PRB index based on the PUCCH resource index, the amount of uplink BWP resources, the number of the cyclic shift sequences, and the PUCCH PRB parameter.

8. The method according to claim 2, wherein performing the random access on the PRB corresponding to the PRB index comprises:
determining an index of the cyclic shift sequence based on the PUCCH resource index and the number of the cyclic shift sequences, wherein the cyclic shift sequence corresponding to the index of the cyclic shift sequence is for multiplexing the PRB corresponding to the PRB index; and
multiplexing the PRB corresponding to the PRB index during the random access by the cyclic shift sequence corresponding to the index of the cyclic shift sequence.

9. The method according to claim 8, wherein the index of the cyclic shift sequence is equal to the PUCCH resource index modulo the number of the cyclic shift sequences.

10. The method according to claim 1, wherein determining the transmission mode for the PUCCH comprises:
receiving frequency hopping indication information transmitted by a network device, wherein the frequency hopping indication information is configured to indicate whether the transmission mode for the PUCCH is frequency hopping transmission or non-frequency hopping transmission; and
determining the transmission mode for the PUCCH based on the frequency hopping indication information.

11. The method according to claim 10, wherein the frequency hopping indication information comprises a PRB index indicator; and
the PRB index indicator indicates whether a PRB used for the random access is a PRB corresponding to a first PRB index or a PRB corresponding to a second PRB index.

12. The method according to claim 1, wherein determining the transmission mode for the PUCCH comprises:
determining the transmission mode for the PUCCH based on a predefined rule.

13. The method according to claim 10, wherein the transmission mode for the PUCCH defaults to non-frequency hopping transmission.

14. The method according to claim 1, wherein the operating frequency band meeting the condition comprises at least one of:
a frequency band number of the operating frequency band is n8;
a frequency band number of the operating frequency band is n26;
a frequency band number of the operating frequency band is n28; or
a frequency band number of the operating frequency band is n100.

15. A method for wireless communication performed by a network device, the method comprising:
in response to an operating frequency band of a terminal meeting a condition, configuring a transmission mode for a physical uplink control channel (PUCCH) by which the terminal performs PUCCH transmission based on the operating frequency band during random access, wherein the transmission mode for the PUCCH comprises frequency hopping transmission or non-frequency hopping transmission; and
performing random access with the terminal based on the transmission mode for the PUCCH.

16. The method according to claim 15, wherein performing the random access with the terminal based on the transmission mode for the PUCCH comprises:
in response to the transmission mode for the PUCCH being non-frequency hopping transmission, determining a physical resource block (PRB) index for the PUCCH based on at least one of: a PUCCH resource index, an amount of uplink bandwidth part (BWP) resources, a number of cyclic shift sequences, or a PUCCH PRB parameter; and
performing the random access with the terminal on a PRB corresponding to the PRB index;
wherein the PUCCH resource index is determined based on a parameter of a physical downlink control channel (PDCCH) used in the random access;
wherein the parameter of the PDCCH comprises at least one of:
control channel element (CCE) information occupied by the PDCCH; or
PUCCH resource allocation information contained in the PDCCH.

17.-30. (canceled)

31. A communication device, comprising:
one or more processors; and
one or more memories storing instructions executable by the one or more processors;
wherein instructions when collectively executed by the one or more processors cause the communication device to act and the terminal and perform the method according to claim 1.

32. A communication device, comprising:
one or more processors; and
one or more memories storing instructions executable by the one or more processors;
wherein the instructions when collectively executed by the one or more processors cause the communication device to act the network device and perform the method according to claim 15.

33. A non-transitory computer-readable storage medium storing instructions, then instructions when executed by one or more processors of the terminal, cause the terminal to perform the method according to claim 1.

34. A non-transitory computer-readable storage medium storing instructions, the instructions when executed by one or more processors of the network device, cause the network device to perform the method according to claim 15.
